(19) United States
(12) Patent Application Publication
(10) Pub. No.: US 2018/0235380 A1
(43) Pub. Date: Aug. 23, 2018

(54) Refrigerated cabinet

(71) Applicant: PAN-DUR HOLDING GMBH & CO. KG, Ravenstein (DE)

(72) Inventor: ALBERT WEISS, RAVENSTEIN (DE)

(21) Appl. No.: 15/901,062

(22) Filed: Feb. 21, 2018

(30) Foreign Application Priority Data
Feb. 23, 2017 (DE) 10 2017 103 751.9

(51) Int. Cl. A47F 3/04; F25D 23/02; E05F 1/04

(52) U.S. Cl. CPC A47F 3/043; E05Y 2900/31; E05F 1/046; F25D 23/021

(57) ABSTRACT

A refrigerated cabinet includes a first plurality of doors arranged along a first long side and configured and disposed to control access to a product space defined within the interior of the cabinet. The cabinet includes a second plurality of doors arranged along a second long side that is disposed opposite the first long side. The second plurality of doors is configured and disposed to control access to the product space. The refrigerated cabinet includes a transverse side connecting the first long side to the second long side. The transverse side includes a third plurality of doors configured and disposed to control access to the product space.

### FIELD OF THE INVENTION

The present invention relates to refrigerated cabinets and individual characteristics of them, whereas the characteristics described below, in any combination, are part of the invention, provided that there are no technical inconsistencies.

It must also be noted that the individual aspects can also be realized in product display cabinets that do not serve the purpose of the cooling of products, such as food. Thus, the individual characteristics can also be realized in product display cabinets that do not serve as refrigerated cabinets.

### SUMMARY OF THE INVENTION

The refrigerated cabinet comprises at least two long cabinets, which are placed with their backs against each other, such that the doors of the two long cabinets are arranged on two opposite, outwardly facing and mutually parallel outer sides of the refrigerated cabinet.

In particular, each individual cabinet of a refrigeration cabinet consisting of several cabinets is to feature its own heat pump arrangement. Moreover, the remaining sections/components/elements are to be present separately for each individual cabinet. Thus, the individual cabinets are preferably so-called “ready-to-plug-in” cabinets, which have all the components necessary for the operation of the cabinet.

It is also advantageous if the refrigerated cabinet features two times X long cabinets (X is between 1 and 10), whereas, in each case, two long cabinets are next to each other with their rear sides turned away from the doors. If there are more than two long cabinets, it is also always the case that the same number of long cabinets are arranged side by side.

Each of the long cabinets features a front side with one or more doors, through which the product space behind it is accessible. It is further provided that a cabinet end section is arranged in the region of one or both end faces of the refrigerated cabinet. The respective cabinet end section serves as a connection between two adjacent long cabinets that are placed with their backs against each other.

In particular, the cabinet end section is arranged in such a manner that, with its rear side, it adjoins one side of each long cabinet, whereas the specified side is the area that is perpendicular to the door front of the long cabinet.

Preferably, the rear side of the cabinet end section is at least partially open, such that shelves can extend from the long sides to the product space of the adjacent cabinet end section.

The cabinet end sections preferably also feature doors, whereas doors are arranged in the region that runs perpendicular to the door front of the long cabinet (=plane formed by the doors of the long cabinet). In addition or alternatively, doors are to be arranged in the plane of the cabinet end section(s) that is/are parallel to or in the same plane in which the doors of the long cabinet are located.

Thus, the refrigerated cabinet may consist of several individual cabinets. Preferably, an even number of long cabinets is present, whereas the long cabinet features doors only in the area of a front side, whereas the front side extends in the width direction of the long cabinet. Thus, a long cabinet has a rear side, two sides running perpendicular to it and the specified front side, through which the product space is accessible.

Preferably, two or in each case two long cabinets have their rear sides against each other, such that the long cabinets feature doors on two sides facing away from each other.

The refrigerated cabinet also includes one or two cabinet end sections. With its rear side, a first cabinet end section can adjoin, in each case, a first side of two adjacently placed long cabinets. With its rear side, a second cabinet end section (if present) can adjoin, in each case, a second side of the specified long cabinet. In place of one long cabinet, more than two long cabinets can be arranged between the two cabinet end sections. Moreover, only one cabinet end section may be present.

All long cabinets of the refrigerated cabinet are to feature doors in the area of its front side. All cabinet end sections are to feature doors in the area of their front side and their two sides. The doors are preferably designed as sliding doors.

In addition, the sides of the long cabinets that adjoin a cabinet end section are not to feature a continuous side wall. Thus, the product space preferably extends from one or two cabinet end sections into the two adjacent long cabinets. If more than two long cabinets are present, the product spaces of laterally adjacent long cabinets are to be connected to each other; that is, they are not separated by partitions.

The refrigerated cabinet preferably has a single product space, whereas this preferably extends into one cabinet end section and two (or X times 2) adjacent long cabinets, or into two cabinet end sections and the long cabinets arranged between them.

The sides of the long cabinet, which do not adjoin either an additional long cabinet or a cabinet end section, may feature a closed, continuous side wall, whereas such side wall may be formed, in whole or in part, by one or more glass panes, in order to enable views into the product space from the specified sides.

Moreover, a part of the invention is also a cabinet end section that features one or more doors both in the area of its front side and in the area of one or both sides.

Thus, when closing one of the doors, adjacent doors approach in a direction running perpendicular to the direction of displacement and, when opening, move away in such direction.

### BRIEF DESCRIPTION OF THE DRAWINGS

Further advantages of the invention are described in the following embodiments. This following is shown, in each case schematically:

FIG. 1 a perspective of a refrigerated cabinet, and

FIG. 2 the view in accordance with FIG. 1 with additional details in the interior.

In the following, characteristics of refrigerated cabinets 1 and their components are described, whereas the individual characteristics can be combined as desired, provided that no obvious inconsistencies arise.

In addition, it must be noted that in figures that feature identical and thus identically represented elements or sections, in some cases, only one of the elements or sections is provided with a reference sign, in order to ensure a proper overview. Finally, it must be clarified that, in all of the figures, not all sections components are provided with a reference sign if they have already been provided with a reference sign in earlier figures.

### DETAILED DESCRIPTION OF EXEMPLARY EMBODIMENTS

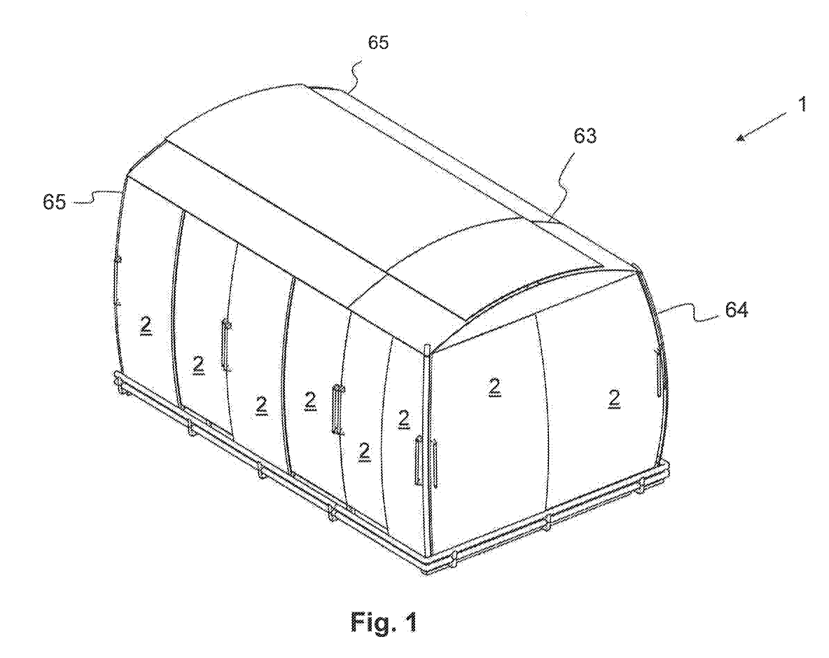

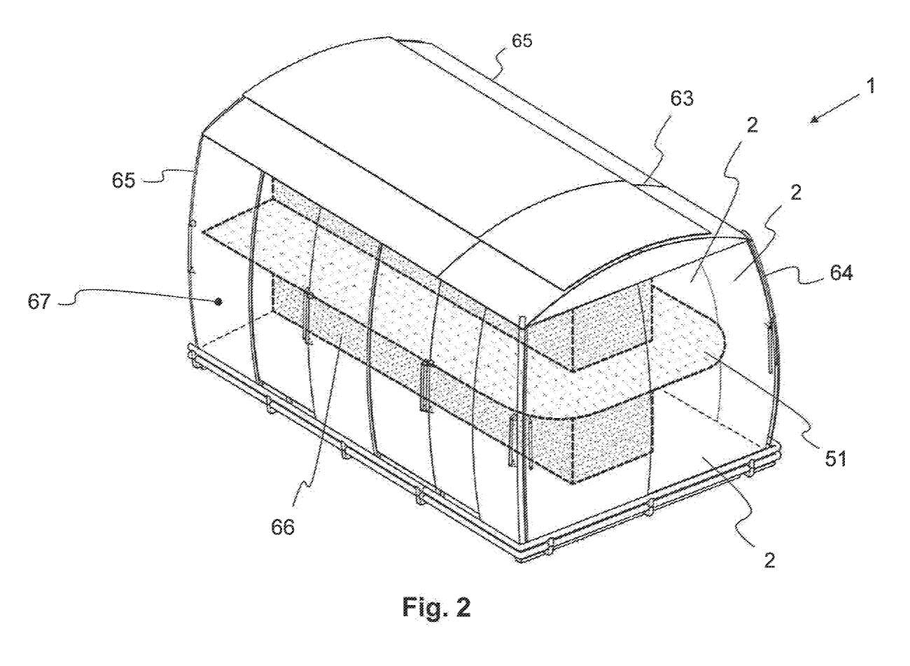

FIGS. 1 and 2 show a possible design of a refrigerated cabinet 1 in accordance with the invention. While FIG. 1 reveals the outer characteristics of the refrigerated cabinet 1, a part of the interior of the refrigerated cabinet 1 can be seen in FIG. 2.

In general, the individual doors 2 include transparent glass panes, such that the view into the product space 67 is ensured even if the doors 2 are closed, even if this does not appear in FIG. 1.

In general, in the case shown, the refrigerated cabinet 1 consists of two long cabinets 65 and one cabinet end section 64, whereas the individual sections are placed against each other and are connected to each other as required. The connection area of the two long cabinets 65 and the cabinet end section 64 is characterized by a line provided with the reference sign 63. Moreover, an additional cabinet end section 64 can also be arranged on the left rear side, such that the two long cabinets 65 can be connected, in the area of each of their end faces, by means of a cabinet end section 64.

Furthermore, FIG. 2 shows that inside the refrigerated cabinet 1, a common display with one or more shelves 51 may be arranged, which shelves may be attached by means of, for example, a center support 66. The shelves 51 extend both into the region of the long cabinets 65 and into the region of the cabinet end section(s) 64, such that a common product space 67 is formed.

In order to be able to reach all of the products placed on the shelves 51 from the outside, it is provided that the cabinet end section 64 features a multiple number of doors 2. Thus, doors 2 may be arranged on the sides that constitute the extension of the long cabinets 65 or their doors. In addition, doors 2 may be arranged in the area of the cabinet end section(s) 64, which extend perpendicular to the doors 2 of the long cabinets 65. As a result, finally, three sides (if only one cabinet end section 64 is present) or even four sides (if two cabinet end sections 64 are present) may be opened by opening the respective doors 2.

Of course, more than two long cabinets 65 may be present between the two cabinet end sections 64; such long cabinets are then arranged side by side.

This invention is not limited to the illustrated and described embodiments. Variations within the framework of the claims, such as any combination of the described characteristics, are also possible, even if they are presented and described in different parts of the description and/or the claims, or in different embodiments, provided that there is no inconsistency regarding the teaching of the independent claims.

### LIST OF REFERENCE SIGNS

1 Refrigerated cabinet
2 Door
51 Shelf
63 Connection area
64 Head cabinet
65. Long cabinet
66 Center support
67 Product space

1-16. (canceled)

17. Refrigerated cabinet comprising:
a frame defining an interior and an exterior and configured to define a product space within the interior, the frame defining a first long side and a second long side disposed opposite the first long side, the frame defining a first transverse side connecting the first long side of the frame to the second long side of the frame;
a first plurality of doors carried by the frame and disposed along the first long side of the frame and configured and disposed to control access to the product space;
a second plurality of doors carried by the frame and disposed along the second long side of the frame, the second plurality of doors being configured and disposed to control access to the product space; and
a third plurality of doors carried by the first transverse side of the frame and configured and disposed to control access to the product space.

18. Refrigerated cabinet as in claim 17, wherein the frame defining a second transverse side spaced apart from the first transverse side and connecting the first long side of the frame to the second long side of the frame.

19. Refrigerated cabinet as in claim 18, further comprising a closed, continuous side wall carried by the second transverse side of the frame and that is at least partially formed by a glass pane, in order to enable views into the product space from outside the side wall.

20. Refrigerated cabinet as in claim 17, wherein the first plurality of doors encloses a first long cabinet section and defines a first outer side of the refrigerated cabinet facing outwardly away from the product space, wherein the second plurality of doors encloses a second long cabinet section and defines a second outer side of the refrigerated cabinet facing outwardly away from the product space, and wherein the first plurality of doors is disposed parallel to the second plurality of doors.

21. Refrigerated cabinet as in claim 20, wherein the third plurality of doors encloses a cabinet end section that defines a third outer side of the refrigerated cabinet facing outwardly away from the product space and disposed to connect the first long cabinet section and the second long cabinet section.

22. Refrigerated cabinet as in claim 21, wherein the cabinet end section includes at least one door from the first plurality of doors, at least one door from the second plurality of doors, and at least one door from the third plurality of doors.

23. Refrigerated cabinet as in claim 21, further comprising a center support disposed in the product space and at least partially within each of the first long cabinet section, the second long cabinet section and the cabinet end section.

24. Refrigerated cabinet as in claim 23, further comprising a plurality of shelves that extend from the center support outwardly into the product space toward the first plurality of doors.

25. Refrigerated cabinet as in claim 24, further comprising a plurality of shelves that extend from the center support outwardly into the product space toward the second plurality of doors.

26. Refrigerated cabinet as in claim 25, further comprising a plurality of shelves that extend from the center support outwardly into the product space toward the third plurality of doors.
